(19) United States
(12) Patent Application Publication
(10) Pub. No.: US 2005/0108071 A1
(43) Pub. Date: May 19, 2005

(54) Systems and methods for approximating optimal distribution via networked systems

(76) Inventors: Kamal Jain, Bellevue, WA (US); Mohammad Mahdian, Cambridge, MA (US)

Correspondence Address: AMIN & TUROCY, LLP, 24TH FLOOR, NATIONAL CITY CENTER, 1900 EAST NINTH STREET, CLEVELAND, OH, 44114, US

(21) Appl. No.: 10/715,170

(22) Filed: Nov. 17, 2003

(51) Int. Cl. G06F 17/60

(52) U.S. Cl. 705/7

(57) ABSTRACT

The present invention leverages an ellipsoid method with an approximate separation oracle to analyze network data routes for data dissemination by a source, yielding an optimization analysis process which compensates for networks with limited capacity links, traditionally an NP-hard problem. In one instance of the present invention, by utilizing a novel generalization of an ellipsoidal means to work with an approximate separation oracle, a primal as well as a dual linear program is solved within the same approximation factor as the approximate separation oracle. Performance of the present invention is within a 1.6 factor.

### TECHNICAL FIELD

The present invention relates generally to data dissemination, and more particularly to systems and methods for providing an optimal distribution of non-streaming data.

### BACKGROUND OF THE INVENTION

Computers were developed to aid people with repetitive tasks that were deemed to be extremely time consuming. Most of the early computers were used for complex mathematical problem solving. The first computing machines were extremely large compared to computers utilized today. Despite their enormous size, the early machines had vastly less computing power than today's machines. Generally speaking, the sizes of computing devices were driven by the sizes of the existing electronic components of that era. This meant that only large research facilities or big businesses could employ computing machines. As new technology allowed for smaller electronic devices to be developed, computing devices also diminished in size. Although still lacking in power by today's standards, the size of the computing machine was reduced enough that it could be placed on a typical desk. Thus, the “desktop computer” was born. This allowed users to have computing technology available in locations other than a central computing building. People found that having the capability to utilize computing technology at their work desk, rather than submitting computing problems to a central location, made them much more productive at their jobs. To make these remotely located computers more accessible, connections were made between the computers to form “networks.” This allowed a greater exchange of information from one computing location to another, and, in some cases, effectively creating one large computing system. Eventually, the idea of moving the desktop computer to the home environment to provide even more convenience for doing work became a reality and networks were extended to include these locations as well.

When the computer was brought into the home, it became obvious that there were other uses for it besides work. This allowed people to view the computer as not only a work tool, but also as a helpful device that could be used to play games, aid in learning, handle telecommunications for the home, and even control home appliances and lighting, for example. Generally speaking, however, a user was restricted to computing information available only on that computer. A game could be installed on the desktop computer and played on that computer, but one could not play others who had computers at other locations. Networking technology came to the rescue by connecting these computers utilizing telephonic modem technology. This permitted individual users to connect via direct dial-up telephone connections. This was great for local telephone calls, but enormously expensive for long distance call access. However, with the advent of the Internet, all that has changed. It provides an inexpensive means, or network, to connect computers from all over the world. This allows users to quickly and easily transmit and receive information on a global scale. Businesses fully embraced this new technology, creating “e-commerce.” Now users can send and receive information and even buy products and services online. This means of accessing a wealth of information and easily processing transactions online has become a staple for our society.

In order for these computing interactions to occur, a stable and robust backbone or network structure must exist. If a network is small and relatively confined, connections between computing systems can be controlled and optimized for the very best in bandwidth and priorities. This would always permit maximum and efficient transferring of data from one computing system to another. However, even with only relatively large networking systems, this type of control over the interconnectivity means is usually not possible. With an extremely large networking system, such as the Internet, generally no control is available for enforcing hardware or bandwidth characteristics for the millions of users. Thus, connection speeds or bandwidth can be 56 kbps at one computing system location or “node” of a network and 6 Mbps at another location. Therefore, there is typically no guarantee of the latency of a particular sized packet of data when it is transferred from one network node to another.

Typically individual users adjust their expectations for downloading or accessing information based upon a pay-for-bandwidth scheme. Thus, their expectations are commensurate with the value to each individual of a high-speed connection. However, the Internet and other large networks generally have multitudes of servers that supply information to the millions of end users. This allows the bandwidth needed to support all of the users to be spread across multiple servers. If a single server were required to support the entire bandwidth, it might create a “bottleneck” in the traffic flow to the users, resulting in greater latencies. Thus, a distributed network with multiple servers allows data to be more efficiently transferred in the network. One method utilized to disseminate similar information is to “mirror” or mimic information from one server on one or more other servers. These mirror servers are often delegated to transfer information based on a particular criteria such as geographic locations of the users or “clients.” This permits clients in the United States to access a mirror server located in the United States. This generally provides a much more robust connection between the server and client by both reducing the distance between them and possibly reducing the number of network nodes that the data must travel through.

Because of the virtues of having data disseminated from one source to multiple sources, it has become an increasingly common method for making data accessible. And, as is typical, with popularity comes an increase in demand for resources and a demand for reduction in the time it takes to create and/or update mirror servers from the mirrored site. As the amount of data increases, it can be generally assumed that it will take longer to transfer that amount of data. To decrease the time, or latency, the connections between the network nodes can be increased. However, often times the connection is not under a particular entities control and the source node must make due with what is provided for that particular network node. Thus, the complete network can be a mixture of many different connections with many different bandwidths. It is even conceivable that if a source node disseminates data updates too quickly, the previous update may not be completed before the latest update is sent. This creates a situation where a mirror server is never completely updated. It is even more confusing for a client node that requests the same data from two different mirror servers and receives two different versions of the same data.

Since the amount of data needed to be disseminated is generally always increasing, accounting for the idiosyncrasies of data dissemination in a network become increasingly paramount to proper distribution of the data in an efficient manner. Thus, broadcasting or multicasting data in a network becomes crucial as the parameters of the network begin to change. Network nodes that were once connected directly to the source or broadcasting node may now be connected indirectly via a network node with a lesser bandwidth connection to the broadcasting node. This creates a complex network node system that is difficult to appropriately model to facilitate in determining the best way to disseminate information in the networked system. The varying bandwidths and interconnectivity of the nodes to the source node create unforeseen bottlenecks, routing connectivity problems, and latency traps that must be accounted for in order to determine an optimized means to disseminate data.

### SUMMARY OF THE INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The present invention relates generally to data dissemination, and more particularly to systems and methods for providing an optimal distribution (e.g., broadcasting, multicasting, etc.) of non-streaming data to nodes in a network. An ellipsoid method with an approximate separation oracle is leveraged to analyze network data routes for data dissemination by a source (e.g., node, server, etc.). This provides an optimized means to maximize update speeds of entities (e.g., nodes and the like) receiving information from the source. By utilizing a novel generalization of an ellipsoidal means to work with an approximate separation oracle, a primal as well as a dual linear program is solved within the same approximation factor as the approximate separation oracle. In one instance of the present invention, performance of the method is within a 1.6 factor (i.e., performance ratio). Thus, the present invention yields an optimization analysis process which compensates for complex networks with limited capacity links, traditionally an NP-hard problem. This allows optimization of networks that were previously thought impossible to optimize due to the varying capacity of the links between the source and receiving nodes.

To the accomplishment of the foregoing and related ends, certain illustrative aspects of the invention are described herein in connection with the following description and the annexed drawings. These aspects are indicative, however, of but a few of the various ways in which the principles of the invention may be employed and the present invention is intended to include all such aspects and their equivalents. Other advantages and novel features of the invention may become apparent from the following detailed description of the invention when considered in conjunction with the drawings.

### BRIEF DESCRIPTION OF THE DRAWINGS

FIG. 1 is a block diagram of a networked server system in accordance with an aspect of the present invention.

FIG. 2 is a block diagram of an optimization system in accordance with an aspect of the present invention.

FIG. 3 is an illustration of a networked system employing an optimization system in accordance with an aspect of the present invention.

FIG. 4 is another illustration of a networked system employing an optimization system in accordance with an aspect of the present invention.

FIG. 5 is a graph illustrating a binary search in accordance with an aspect of the present invention.

FIG. 6 is another graph illustrating a binary search in accordance with an aspect of the present invention.

FIG. 7 is a flow diagram of a method of optimizing distribution in a networked system in accordance with an aspect of the present invention.

FIG. 8 is a flow diagram of a method of optimizing distribution of a networked system based on a desired system parameter in accordance with an aspect of the present invention.

FIG. 9 is a flow diagram of a method of determining bounds of an optimum distribution of a networked system in accordance with an aspect of the present invention.

FIG. 10 illustrates an example operating environment in which the present invention can function.

FIG. 11 illustrates another example operating environment in which the present invention can function.

### DETAILED DESCRIPTION OF THE INVENTION

The present invention is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

As used in this application, the term “component” is intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a computer component. One or more components may reside within a process and/or thread of execution and a component may be localized on one computer and/or distributed between two or more computers. A “thread” is the entity within a process that the operating system kernel schedules for execution. As is well known in the art, each thread has an associated “context” which is the volatile data associated with the execution of the thread. A thread's context includes the contents of system registers and the virtual address belonging to the thread's process. Thus, the actual data comprising a thread's context varies as it executes.

The present invention provides fast approximation systems and methods for optimum distribution in a network, for example, such as a broadcast of non-streaming data, and a generalization of an ellipsoidal method to work with an approximate separation oracle to solve primal as well as dual linear programs. For instance, suppose a network is given with a distinguished node called “broadcaster.” This broadcaster broadcasts non-streaming data (e.g., a web caching company renews the caches at several of its mirror sites). Various nodes in the network may have their caches updated with non-streaming data from the broadcaster node through limited capacity sub-networks. The present invention maximizes the update speed of the nodes by analyzing the sub-networks through which the broadcaster can route data to the nodes utilizing the ellipsoidal method with an approximate separation oracle. Optimizing the time it takes to renew all the mirror sites is ordinarily classified as a hard problem to solve. The present invention overcomes this obstacle with performance that is within a 1.6 factor. The present invention utilizes a novel generalization of the ellipsoid algorithm to employ an approximate separation oracle to solve the primal as well as the dual linear program within a same approximation factor as the approximate separation oracle. Linear programs naturally appear in many optimization problems, making the present invention invaluable for other parameters as well.

Thus, the present invention provides a means to determine an optimum distribution. The objects and/or entities of the distribution can vary from data to objects to physical structures such as infrastructures such as roads and the like. A networked system (i.e., a system (e.g., computer network, highway network, communications network, and the like) linked together in some manner or form such as by roads, communication lines, radar, satellite, and the like) can be exemplified by a graph with nodes and edges. The nodes represent corresponding terminals or points of interaction for a networked system. These can include computer terminals (e.g., servers) in a computing network such as the Internet or cities in a network of highways. The edges represent the means to which items/entities are transferred from one node to another. In order to determine the efficiency of transferring items, a metric, such as cost and the like, is established for the edges. The cost can be a literal dollar value, and/or it can represent such parameters as time, bandwidth, amount of effort, and the like. In graph terminology, this metric is referred to as the “weight” of the edge. Thus, higher weights can equate to an increased metric value such as increased cost.

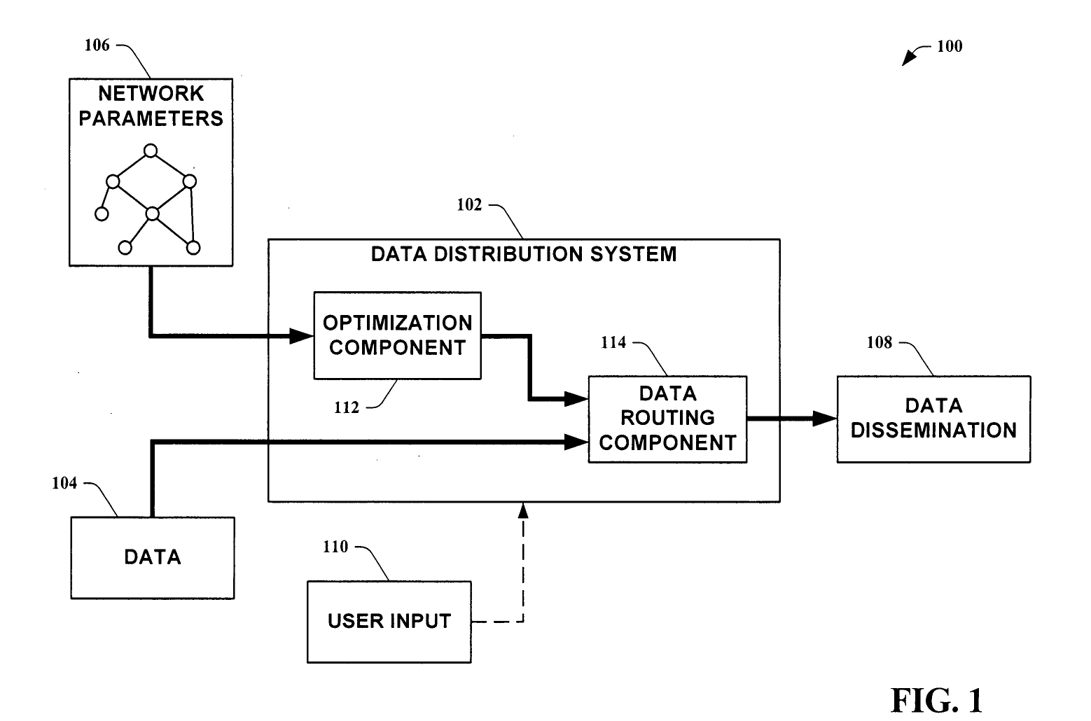

In FIG. 1, a block diagram of a networked server system 100 in accordance with an aspect of the present invention is illustrated. The networked server system 100 comprises a data distribution system 102 with an optional user input 110, input data 104, network parameter data 106, and data dissemination output 108. The data distribution system 102 is comprised of an optimization component 112 and a data routing component 114. In this instance of the present invention, the data distribution system 102 distributes (i.e., disseminates) data 104 over a network (not shown). It 102 provides an optimized data distribution process such that end users receive data efficiently. To accomplish this, network parameter data 106 is input into the optimization component 112. This component 112 determines which network parameter to utilize as a metric for establishing efficiency of data dissemination over that particular network. It 112 then analyzes the network based on this parameter to determine optimal data dissemination via the network's nodes. This determination is then passed to the data routing component 114. This component 114 takes the data 104 to be distributed and, utilizing the optimal data dissemination determined by the optimization component 112, disseminates the data 104 to nodes via the network. The optional user input 110 provides a means, such as via a keyboard, mouse, touch screen, pre-programming, and the like, to input user preferences which can effect and/or facilitate optimizing the data dissemination 108. Such factors can include, but are not limited to, which parametric aspect of the network to utilize for optimization, a cost of an associated parametric value, and even biasing such as increasing weighting of an edge utilized to resolve a graph representative of the network in the optimization.

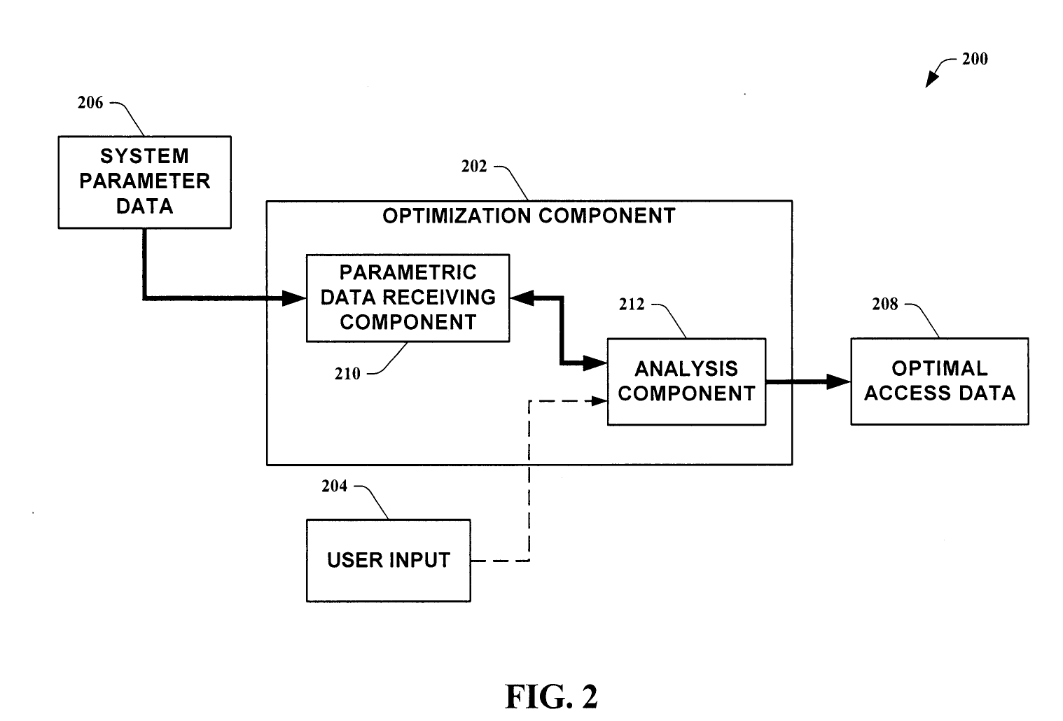

Turning to FIG. 2, a block diagram of an optimization system 200 in accordance with an aspect of the present invention is shown. The optimization system 200 is comprised of an optimization component 202 with an optional user input 204, system parameter data 206, and optimal access data 208. The optimization component 202 is comprised of a parametric data receiving component 210 and an analysis component 212. The parametric data receiving component 210 receives the system parameter data 206 and determines which parameter and its data is desired by the analysis component 212 for determining an optimum distribution. In this instance of the present example, the desired parameter data can be determined by the analysis component 212, determined as a preprogramming of the parametric data receiving component 210, and/or input via either the analysis component 212 and/or the parametric data receiving component 210 via the optional user input 204 (e.g., mouse, keypad, handheld device, touch screen, keyboard, etc.). FIG. 2 only illustrates the instance of the present invention where the optional user input 204 only interfaces with the analysis component 212. The desired parameter can include, but is not limited to, such items as cost, length, bandwidth, and latency and the like for dissemination of items/entities via interaction points (e.g., nodes) in a system. The analysis component 212 determines an optimal means for distribution by utilizing the desired parameter from the parametric data receiving component 210. It 212 utilizes an adapted linear programming optimization method, based on separation oracle(s), to employ an approximate separation oracle to solve a primal and dual linear program within a same approximation factor as the approximate separation oracle associated with the desired parameter data. The optimization component 202 can be utilized with systems, for example, such as computer networking systems, highway network systems, and integrated circuit chip networks, and the like. Any system with links and interactive points that desires distribution of an item/entity can effectively utilize the present invention.

In order to better comprehend the importance of the present invention, it is helpful to understand how networked systems are modeled in relation to distribution. A well known historical geometer, Jacob Steiner, developed a geometric point later named a “Steiner point.” The notion of the Steiner point has been utilized in graph resolution, namely as it applies to Steiner trees. A Steiner tree is a minimum-weight tree connecting a designated set of vertexes, called terminals, in a weighted graph. The tree can also include non-terminals, called Steiner vertexes or Steiner points. In the Steiner tree packing problem (i.e., how best to distribute in a network or graph utilizing Steiner trees), the objective is to find a maximum number of edge-disjoint Steiner trees in a given graph. The problem in its full generality (where for each Steiner tree, a different set of terminals is given) has applications, for example, in VLSI (very large scale integration) circuit design (see generally, A. Martin and R. Weismantel; Packing Paths and Steiner Trees: Routing of Electronic Circuits; CWI Quarterly; 6:185-204; 1993, M. Grötschel, A. Martin, and R. Weistmantel; The Steiner Tree Packing Problem in VLSI-Design; Mathematical Programming; 78:265-281; 1997, and M. Grötschel, A. Martin, and R. Weistmantel; Packing Steiner Trees: A Cutting Plane Algorithm and Computational Results; Mathematical Programming; 72:125-145; 1996). In this application, a Steiner tree is needed to share an electric signal by a set of terminal nodes.

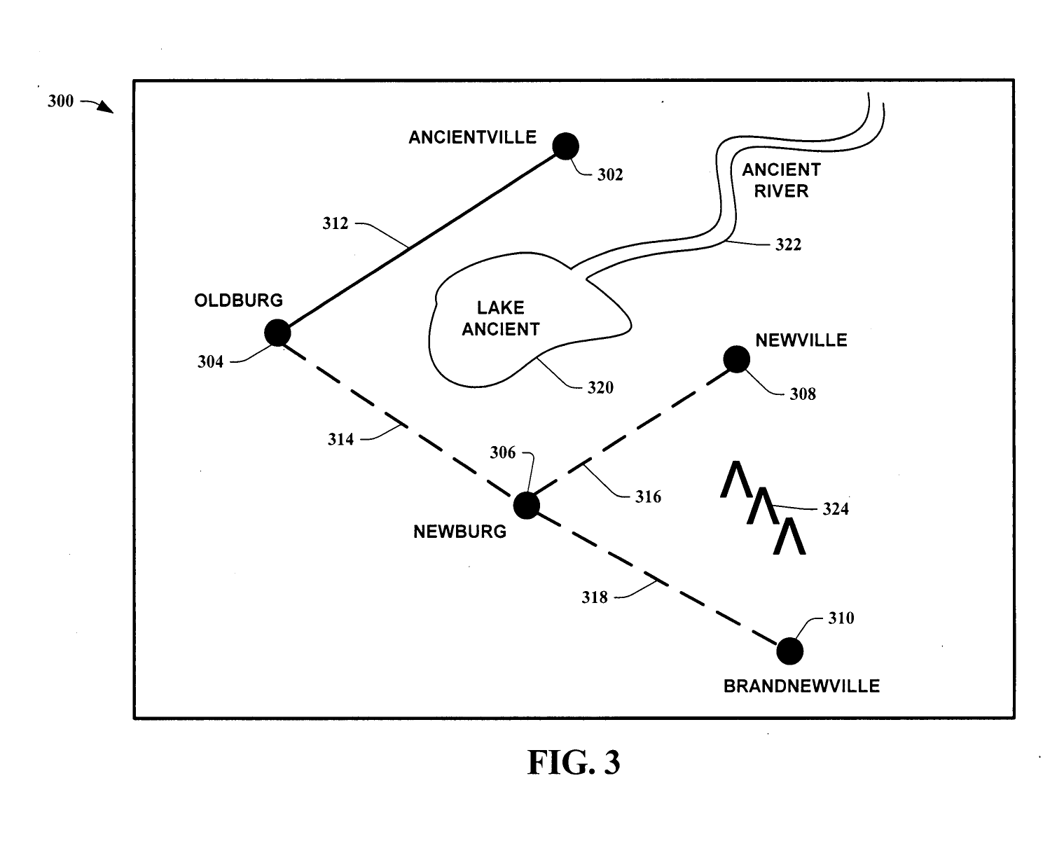

Other uses include solving transportation problems between cities. Referring to FIG. 3, an illustration of a networked system 300 employing an optimization system in accordance with an aspect of the present invention is depicted. The example system 300 is comprised of five interactive points or nodes (i.e., cities), namely Ancientville 302, Oldburg 304, Newburg 306, Newville 308, and Brandnewville 310. In this example, Ancientville 302 is a well established city that is presently connected to Oldburg 304 via highway 312. An expansion has taken place with an addition of new cities (nodes) represented by Newburg 306, Newville 308, and Brandnewville 310. The present invention is employed to determine how to optimally interconnect the new cities 306-310 with Ancientville 302. A desired cost parameter is chosen to be cost per mile of laying highway over terrain and obstacles between each city (node). The cost per mile between two cities (nodes) is influenced by such factors as Lake Ancient 320 located between Ancientville 302 and Newburg 306, Ancient River 322 located between Ancientville 302 and Newville 308, and mountains 324 located between Newville 308 and Brandnewville 310. The lake 320, the river 322, and the mountains 324 present substantial obstacles to laying highway and, thus, drastically increase the cost per mile (desired cost parameter) between associated cities (nodes). Therefore, the present invention optimizes distribution (i.e., highway interconnections in this example) between nodes (cities) utilizing the desired cost parameter. In this example, dashed highways 314-318 represent optimum paths (distributions) between the nodes (cities). Thus, it is evident from FIG. 3, that despite some nodes being physically closer, the optimum path is via other nodes in order to reduce the desired cost parameter. This example is illustrated to show that optimization with the present invention is not solely limited to computer type networks and the like.

In yet another example application, the need for resolving the Steiner tree packing problem arises in the Internet domain. For this example, imagine that a given graph represents a network. Suppose one of the nodes in the graph is the broadcaster. All other nodes are, for illustrative purposes, either users and/or routers (also called switches). The broadcaster desires to broadcast as many streams of movies as possible, so that users have the maximum number of choices. Each stream of movie is broadcasted via a Steiner tree connecting all the users with the broadcaster. Since this example allows parallel edges, it can also be assumed that each link can carry only one broadcast. So, in essence, it is desirable to find the maximum number of edge-disjoint Steiner trees connecting all the users and the broadcaster.

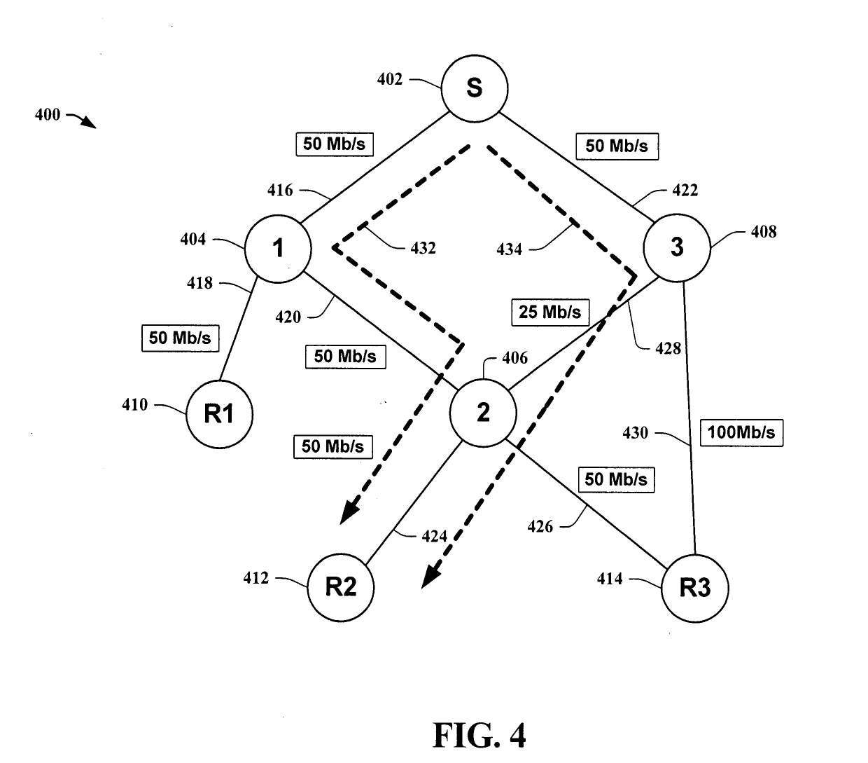

In FIG. 4, another illustration of a networked system 400 employing an optimization system in accordance with an aspect of the present invention is shown. The system 400 is comprised of a source node S (e.g., broadcaster) 402; routing nodes (e.g., switches) one 404, two 406, and three 408; and receiving nodes (e.g., end users) R1 410, R2 412, and R3 414. The nodes 402-414 communicate via links 416-430. In this example, the links 416-430 do not all have the same bandwidth (i.e., capacity). Links 416-426 have a 50 Mb/s bandwidth while link 428 is 25 Mb/s and link 430 is 100 Mb/s. Thus, as an example, an instance of the present invention is employed to determine an optimum distribution path from the source node 402 to the receiving node R2 412. A first path 432 from the source node 402 to R2 412 via routing node one 404 and routing node two 406 permits a 50 Mb/s data transfer to occur. A second path 434 from the source node 402 to R2 412 via routing node three 408 and routing node two 406 permits, at most, a 25 Mb/s data transfer to occur. This is due to a data transfer bottleneck that occurs between routing node three 408 and routing node two 406 with link 428 only allowing 25 Mb/s bandwidth. Thus, if a 50 Mb/s transfer is required, this second path 434 would fail. Other paths either would not reach R2 412 or would require more time due to additional routing nodes in the paths. This is a relatively simple illustration of a much more complex problem that the Steiner tree packing problem addresses. Typically, a “master link” or main connection to a source node limits a maximum total capacity that can be transferred to receiving nodes. Additionally, there is often more than one acceptable path to reach all of the receiving nodes. This means that the bandwidth of the master link is shared between all routing solutions (e.g., Steiner trees in a network). Thus, finding a solution to optimize distribution becomes extremely hard to solve as a network size increases. The present invention provides a solvable approximation to the fractional Steiner tree packing problem.

From a theoretical perspective, both extremes of the Steiner tree packing problem are fundamental theorems in combinatorics. One extreme of the problem is when only two terminals exist. In this extreme case, a Steiner tree is just a path between the terminals, so the problem becomes the well-known Menger theorem (see generally, K. Menger. Zur Allgemeinen Kurventheorie; Fund. Math.; 10:95-115; 1927). The other extreme case is when all the vertices are terminals. In this case, a Steiner tree is just a spanning tree of a graph, so the problem becomes the classical Nash-Williams-Tutte theorem (see generally, C. St. J. A. Nash-Williams; Edge Disjoint Spanning Trees of Finite Graphs; J Lond Math. Soc.; 36:445-450; 1961 and W. T. Tutte; On the Problem of Decomposing a Graph into n Connected Factors; J Lond Math. Soc.; 36:221-230; 1961).

It is often desirable to resolve the problem of packing the maximum number of Steiner trees fractionally. The present invention provides a means for finding an α-approximation algorithm for this problem that is equivalent to finding an α-approximation algorithm for the minimum Steiner tree problem. In addition, a 1.598-approximation algorithm for the fractional Steiner tree packing problem is also obtained via the present invention. This also shows that it is hard to find a polynomial time approximation scheme (PTAS) for a (fractional or integral) Steiner tree packing problem.

The fractional Steiner tree packing problem can be formulated by the following primal linear program. In the following, T denotes a collection of all S -Steiner trees in a graph G and cₑ is a (given) capacity of an edge e (other parameters besides capacity can be utilized for a given networked system as well). T denotes an S-Steiner tree from the S-Steiner tree collection T and E represents all edges in T. Thus,
maximise Σ_{T∈T}x_{T}
subject to ∀e∈E:Σ_{Te∈T}x_{T}≦cₑ
∀T∈T:x_{T}≦0 (Eq. 1)
where X_{T} represents a capacity variable relating to the tree T (X_{T} can represent other variables for a given networked system as well such as length and cost and the like when another parameter besides cₑ is selected for evaluating the edges). This variable can relate to parametric data relative to a network represented by a graph containing Steiner trees. Thus, there are many variables but a small number of constraints for this linear program, making it NP-hard (“NP” is the class that a Nondeterministic Turing machine accepts in Polynomial time, and the complexity class of decision problems that are intrinsically harder than those that can be solved by a nondeterministic Turing machine in polynomial time are “NP-hard”) to solve.

This problem is a natural relaxation of the Steiner tree packing problem, and it is possible to get a good upper bound by solving the above linear program. A dual of the primal linear program (Eq. 1) is as follows:
minimize Σ_{e∈E}cₑyₑ
∀T∈T:Σ_{e∈T}yₑ≦1
∀e∈E:yₑ≦0 (Eq. 2)
where yₑ represents a capacity of an edge in tree T. This yields a smaller number of variables with a finite set of edges, and, therefore is more solvable than the primal linear program (Eq. 1). However, the number of constraints has increased.

In other words, the dual linear program (Eq. 2) captures the following problem: Assign non-negative weights to edges of a graph G in such a way that a minimum weight S -Steiner tree (where S is a set of at least two vertices) has weight at least 1, and a linear function of the weights of the edges is minimized. The difficulty in solving this dual linear program arises from the fact that a separation oracle (classifier that indicates whether a solution is feasible or not) for the above dual linear program is the Steiner tree problem, and is therefore still NP-hard to solve. The present invention provides that it is possible to utilize known approximation methods for the Steiner tree problem as an approximate separation oracle in an ellipsoid method to find an approximate fractional packing of Steiner trees. The present invention also provides that the converse is also true, i.e., an approximation method for the fractional Steiner tree packing problem implies an approximation method for the minimum Steiner tree problem. Thus, there is an α-approximation algorithm for a maximum fractional Steiner tree packing problem if and only if there is an α-approximation algorithm for a minimum Steiner tree problem. Therefore, assuming there is a polynomial time α-approximation algorithm A for finding the minimum weight Steiner tree in a given weighted graph for a given set of required points, there is a polynomial time α-approximation algorithm for finding a maximum fractional packing of Steiner trees in a given capacitated graph for a given set of required points.

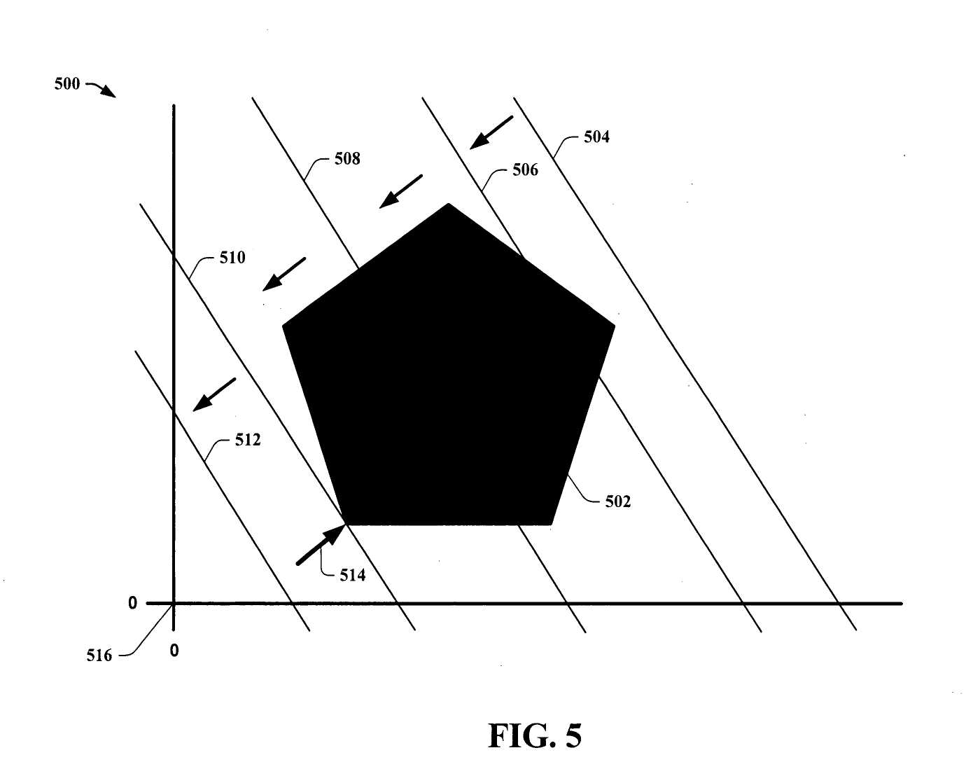

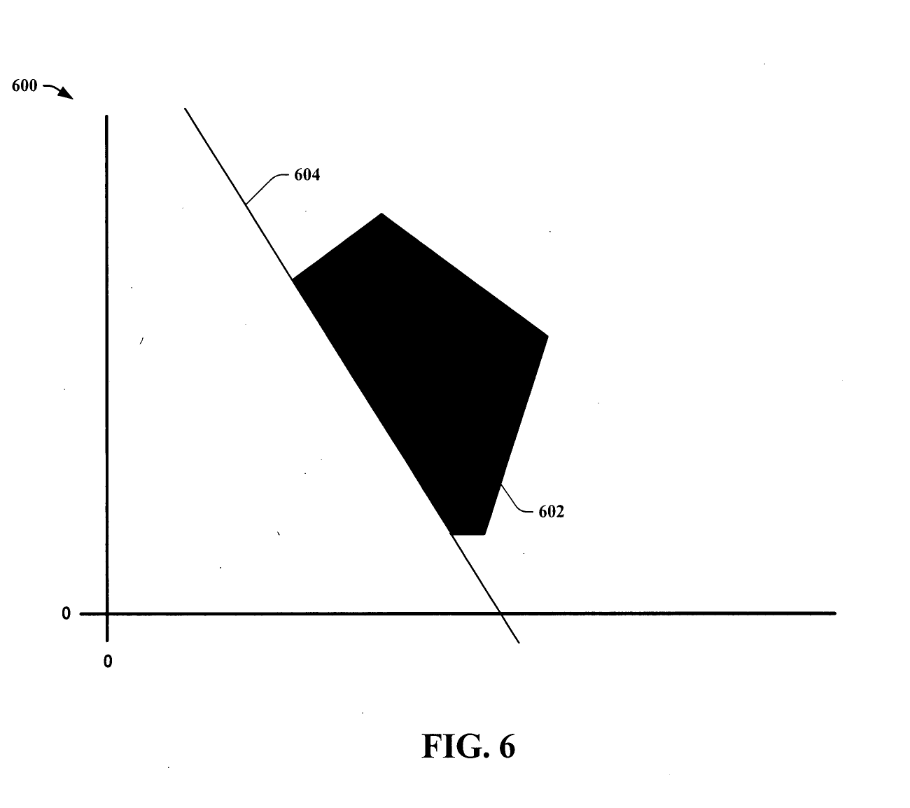

It is NP-hard to optimize with an ellipsoid or Vaidya's (see generally, P. M. Vaidya; Geometry Helps in Matching; SIAM J Comput.; 18:1201-1225; 1989) algorithm. Therefore, an ellipsoid algorithm (or the more efficient Vaidya's algorithm) is employed on the dual linear program (Eq. 2) utilizing an algorithm A as a separation oracle. More precisely, the inequality Σ_{e∈E}cₑyₑ≦R is added to the dual linear program, and a binary search is employed to find a smallest value of R for which the dual linear program is feasible. In two dimensions, constraints of an equation form, for example, sides of a polygon (two dimensional polytope) 502 as shown in a graph 500 illustrated in FIG. 5. In higher dimensions, the constraints form “polytopes.” Lines 504-512 help to limit the polytope in its infinite direction, making it finite. This permits a binary search to be utilized along each line to determine if a point of the polytope lies along that line while moving the line ever closer to the origin 516. In this example, line 504 is beyond an upper bound of the polygon 502, while line 512 is below the polygon 502 and is therefore infeasible. Line 510 contains a point 514 at a lower limit of the polygon 502 and, thus, creates a lower bound. FIG. 6 illustrates the fact that a line 604 is evaluated as a boundary line to a polygon or polytope forming a new polygon 602. This allows a determination to be made as to whether a polytope is empty or not and, thus, if it is feasible or not. Resolving this issue is NP-hard, but can be solved approximately.

Solving a feasibility problem for a linear program is called “separation oracle” because if a given value assignment is feasible then the separation oracle says it is feasible, else it outputs a constraint of a linear program which is not satisfied. Thus, given the present invention, whenever a feasibility problem can be solved reasonably, an optimization problem can also be solved reasonably. Or, in other words, if a feasibility linear program can be solved approximately, then the present invention can also solve an optimization with the same approximation factor. Therefore, the present invention provides a means to determine optimization approximately via utilization of a feasibility determination means. The separation oracle acts as follows: first, it checks the inequality Σ_{e∈E}cₑyₑ≦R. Next, it runs the algorithm A to find the approximate minimum weight Steiner tree in the graph, utilizing yₑ's as the weights of edges. If the answer that A finds has weight less than 1, then yₑ's are not a feasible solution of the dual linear program, and the Steiner tree of weight less than 1 results in a separating hyperplane. If the approximate minimum Steiner tree that A finds has weight at least 1, then yₑ's is accepted as a feasible solution and, therefore, the ellipsoid method decides that the dual linear program is feasible. Of course, since A is just an approximation algorithm, the above conclusion might be incorrect, and the dual linear program might actually be infeasible. However, since the approximation factor of A is at most α in this case, αyₑ's constitute a feasible solution of the dual linear program with R replaced by αR. Therefore, if R* is a minimum value of R for which the method decides that the dual linear program is feasible, then the dual linear program is infeasible for R*−Σ (where E depends on the precision of the algorithm), and is feasible for αR*. Therefore, an optimum solution of the dual linear program is between R* and αR*. One skilled in the art will appreciate that the above algorithm could have touched (i.e., considered) at most a polynomial (i.e., small) number of constraints in the dual linear program. So that means variables in the primal linear program corresponding to these small number of constraints are enough to produce a good solution. All other variables of the primal linear program are ignored, so the primal linear program is now reduced to a small linear program which can be solved with any linear program solver.

The above method computes an approximate value of a solution of the primal linear program (Eq. 1). In order to compute an actual solution, a technique is utilized as described in B. Carr and S. Vempala; Randomized Meta-Rounding; Proc. Of the 32^{nd} ACM Symposium on the Theory of Computing (STOC '00); 2000). The total number of separating hyperplanes found by the above separation oracle while running the ellipsoid method for R*−Σ is bounded by a polynomial. These separation oracles are enough to show that the solution of the dual linear program (Eq. 2) is at least R*. Therefore, if a set of primal variables that correspond to these separating hyperplanes is considered, a set of polynomially many primal variables is provided. By linear program-duality, if values of other variables are fixed to 0, a resulting linear program still has solution at least R*. However, after fixing the values of other variables to 0, a polynomial size linear program is obtained, which can be solved in polynomial time, and provides a means to find an optimum solution. Accordingly, this optimum solution has value at least R*. Furthermore, the optimum solution of the dual linear program (Eq. 2), and therefore the primal linear program (Eq. 1) is not more than αR*.

Conversely, assume there is an α-approximation algorithm A for finding the maximum fractional Steiner tree packing in a given capacitated graph with a given set of required points. This means that if a polytope defined by inequalities of the dual linear program (Eq. 2) is denoted by P, then the present invention can approximately optimize on P in any given direction. In a polar, this means that there is a procedure that for any given line l, finds (approximately) a first facet of the polar of P that intersects l. This implies that there is an approximate separation oracle for the polar of P. Utilizing this separation oracle and the method supra, the present invention can obtain an algorithm that for any given direction, finds an approximate optimum point in the polar of P along that direction. This means that for P, there is a procedure A′ that for any given line l, finds (approximately) a first facet of P that intersects l. It is not difficult to observe that utilizing A′, the present invention can (approximately) solve the minimum Steiner tree problem. Furthermore, the above reduction preserves the approximation factor of the method.

Additionally, the above method together with the algorithm of Hougardy and Promel (S. Hougardy and H. J. Promel; A 1.598 Approximation Algorithm for the Steiner Problem in Graphs; Proc. Of 10^{th} ACM-SIAM Symp. On Disc. Alg. (SODA); pages 448-453, 1999) and APX-completeness proof of Bern and Plassmann (M. Bern and P. Plassmann; The Steiner Problem With Edge Lengths 1 And 2; Information Processing Letters; 32(4): 171-176; 1989) for the minimum Steiner tree problem implies the following. There is a 1.598-approximation algorithm for the fractional Steiner tree packing problem. The fractional Steiner tree packing problem is APX-hard (a problem is called APX-hard if the existence of a PTAS for this problem would imply that for every problem in APX a PTAS exists). The problem of packing the maximum number of edge-disjoint Steiner trees is APX-hard.

The present invention provides that if there is an a -approximation algorithm for the Steiner tree packing problem, then by replacing each edge by several parallel edges, one can obtain an (α−Σ)-approximation algorithm for the fractional Steiner tree packing problem, for any Σ>0. Additionally, one skilled in the art will appreciate that utilizing Mader's splitting-off lemma (see generally, J. Bang-Jensen, A. Frank, and B. Jackson; Preserving And Increasing Local Edge-Connectivity In Mixed Graphs; SIAM J. Discrete Math.; 8(2):155-178; 1995) one can obtain a combinatorial 2-approximation algorithm for the fractional Steiner tree packing problem. The idea is to replace each edge by two parallel edges, and perform the splitting-off procedure on the Steiner points.

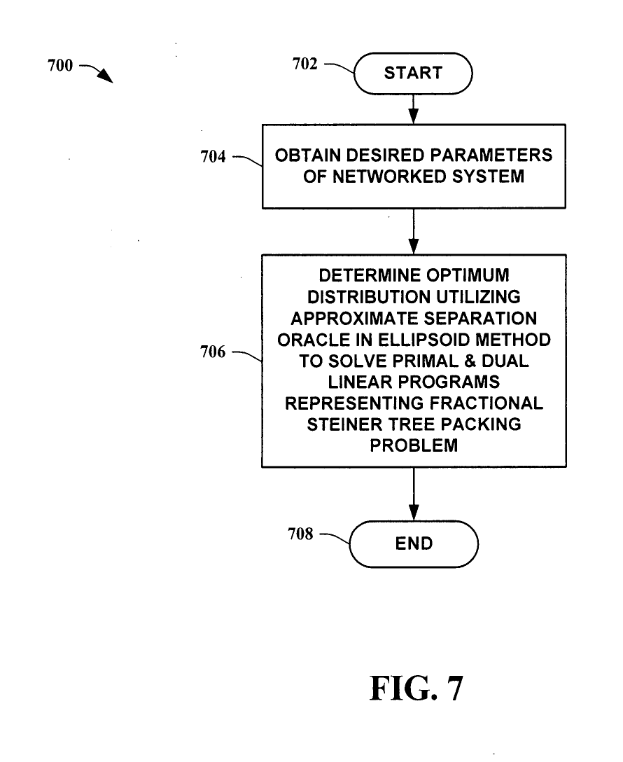

In view of the exemplary systems shown and described above, methodologies that may be implemented in accordance with the present invention will be better appreciated with reference to the flow charts of FIGS. 7-9. While, for purposes of simplicity of explanation, the methodologies are shown and described as a series of blocks, it is to be understood and appreciated that the present invention is not limited by the order of the blocks, as some blocks may, in accordance with the present invention, occur in different orders and/or concurrently with other blocks from that shown and described herein. Moreover, not all illustrated blocks may be required to implement the methodologies in accordance with the present invention.

The invention may be described in the general context of computer-executable instructions, such as program modules, executed by one or more components. Generally, program modules include routines, programs, objects, data structures, etc., that perform particular tasks or implement particular abstract data types. Typically the functionality of the program modules may be combined or distributed as desired in various embodiments.

In FIG. 7, a flow diagram of a method 700 of optimizing distribution in a networked system in accordance with an aspect of the present invention is shown. The method 700 starts 702 by obtaining desired parameters relating to a networked system that needs to be optimized 704. This entails selecting a performance parameter such as, for example, cost, capacity, distance, latency, and the like. The performance parameter is then utilized to gather information relating to the parameter such as link capacities of a computer network, for example. An optimum distribution is then determined utilizing an approximate separation oracle in an ellipsoid method to solve primal and dual linear programs relating to the networked system and representing a fractional Steiner tree packing problem 706, ending the flow 708. Typically, a primal linear program is employed to represent the fractional Steiner tree packing problem and is known to be NP-hard to solve. A dual linear program can be employed, as discussed infra, as a feasibility linear program and solved approximately via a separation oracle. The same approximation factor utilized in the feasibility solution is then employed to solve the optimization of the networked system. The approximate solution of the optimization is then utilized to establish an optimal distribution method for the networked system.

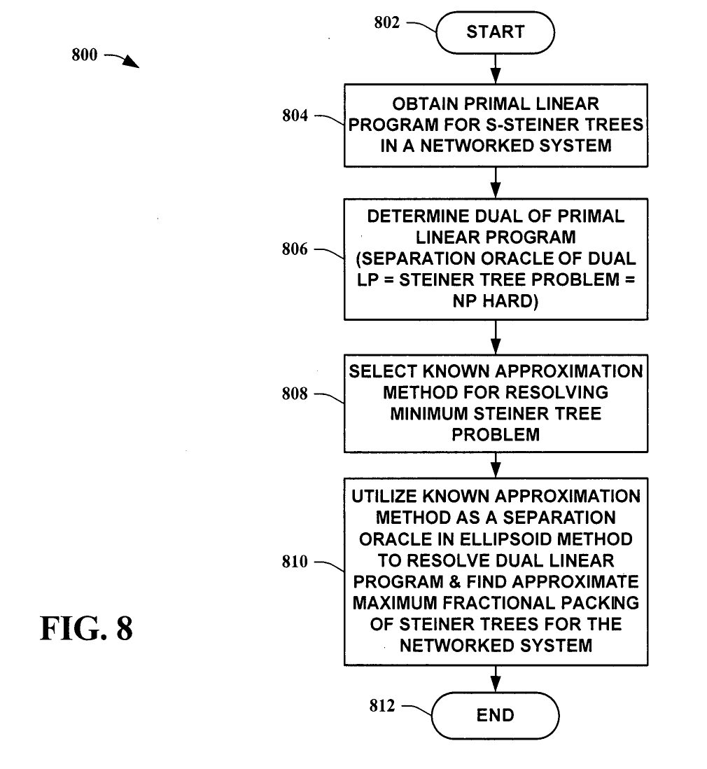

Turning to FIG. 8, a flow diagram of a method 800 of optimizing distribution of a networked system based on a desired system parameter in accordance with an aspect of the present invention is illustrated. The present invention allows a fast approximation based upon a desired performance parameter. As mentioned supra, the performance parameter can be, for example, distances between nodes, capacity of links between nodes, cost of access between nodes, and latencies between nodes, and the like. Once the desired performance parameter is selected, data associated with that parameter is obtained to facilitate in solving optimization of the system's distribution. Each system can have many different parameters that can affect distribution in a system. The method 800 starts 802 by obtaining a primal linear program for S-Steiner trees in a networked system related to a particular performance parameter of the networked system 804. A dual of the primal linear program is then resolved 806. A separation oracle for the dual linear program equates to solving a Steiner tree problem which is NP-hard to solve. Thus, a better method is required to provide a solution. Therefore, a known approximation method for resolving a minimum weight Steiner tree problem is selected 808. This approximation method is utilized as an approximate separation oracle in an ellipsoid method to facilitate in resolving the dual linear program and finding an approximate maximum fractional packing of Steiner trees found in the networked system 810, ending the flow 812. The approximate separation oracle is utilized to determine an approximate solution within a 1.6 factor (typically less than 1.598 and depending on circumstances, even less than 1.53). The approximate solution, based on the desired performance parameter, is then employed to determine an optimized distribution for the networked system.

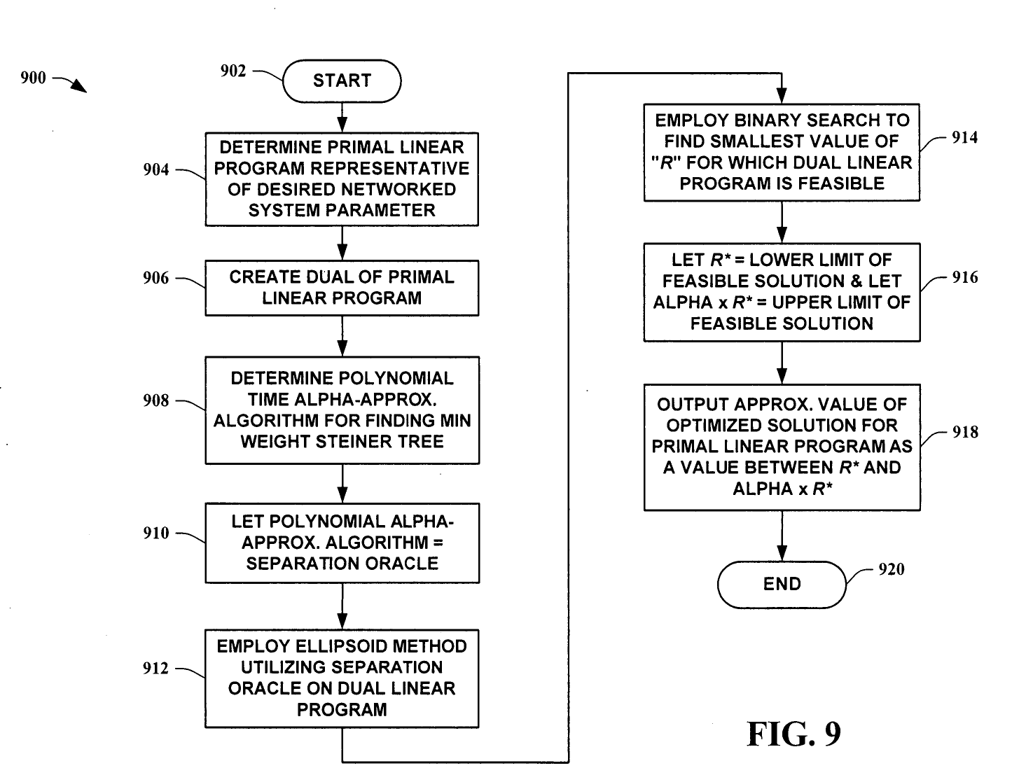

Referring to FIG. 9, a flow diagram of a method 900 of determining bounds of an optimum distribution of a networked system in accordance with an aspect of the present invention is depicted. The method 900 starts 902 by determining a primal linear program that is representative of a desired networked system parameter 904, such as, for example:
maximise Σ_{T∈T}x_{T}
subject to ∀e∈E:Σ_{T:e∈T}x_{T}≦cₑ
∀T∈T:x_{T}≧0 (Eq. 1)
where T denotes a collection of all S -Steiner trees in a graph G and cₑ is a (given) capacity of an edge e (other parameters besides capacity can be utilized for a given networked system as well) and X_{T} represents a capacity variable relating to the tree T (X_{T} can represent other variables for a given networked system as well such as length and cost and the like when another parameter besides cₑ is selected for evaluating the edges). As described previously, this desired parameter can include, for example, cost, time, length, capacity, and the like. A dual of the primal linear program is then created 906, such as, for example:
minimize Σ_{e∈E}cₑyₑ
subject to ∀T∈T:Σ_{e∈T}yₑ≧1
∀e∈E:yₑ≧0 (Eq. 2)
A polynomial time α-approximation algorithm is then determined for finding a minimum Steiner tree 908. The polynomial α-approximation algorithm is then allowed to become an approximate separation oracle 910. An ellipsoid method is then applied to the dual linear program utilizing the approximate separation oracle 912, such as, for example, inequality Σ_{eΣE}cₑyₑ≦R is added to the dual linear program. A binary search method is then employed to find a smallest value of R, namely R*, for which the dual linear program is feasible 914. Thus, an optimum solution has a value of at least R*. Furthermore, the optimum solution of the dual linear program (Eq. 2), and therefore the primal linear program (Eq. 1) is not more than αR*. Therefore, let R* equal a lower limit of the feasible solution and let αR* equal an upper limit of the feasible solution 916. An approximate value for an optimized solution for the primal linear program is then output as a value between R* and αR* 918, ending the flow 920.

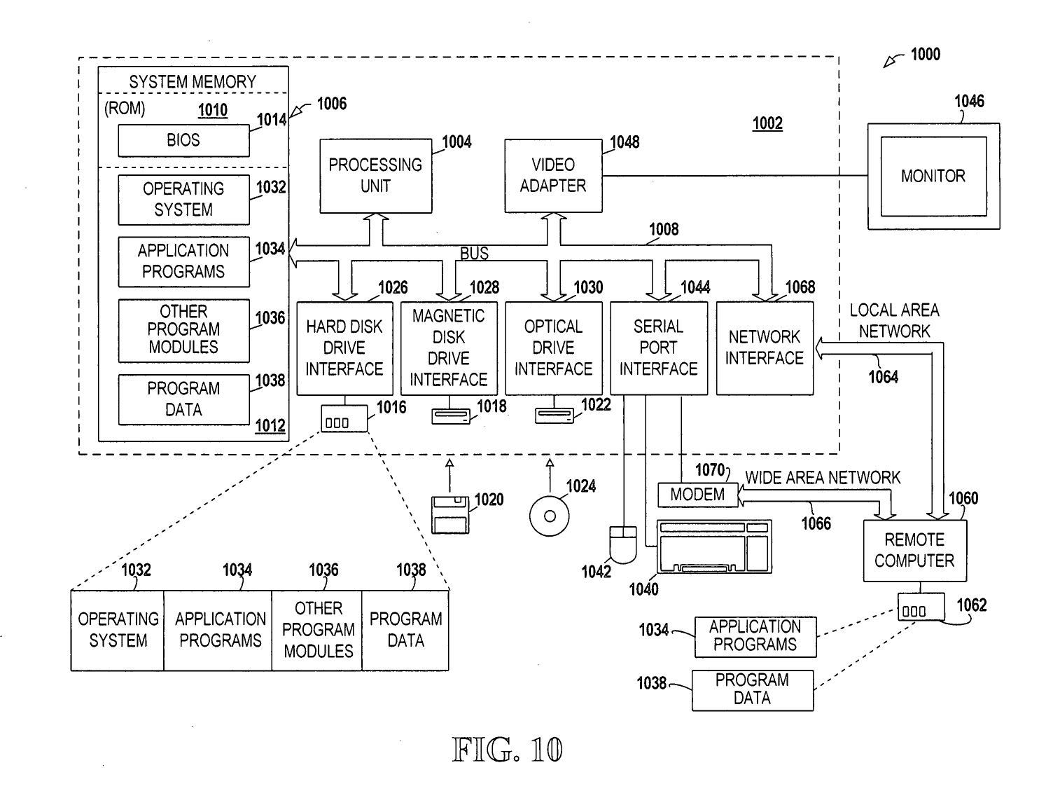

In order to provide additional context for implementing various aspects of the present invention, FIG. 10 and the following discussion is intended to provide a brief, general description of a suitable computing environment 1000 in which the various aspects of the present invention may be implemented. While the invention has been described above in the general context of computer-executable instructions of a computer program that runs on a local computer and/or remote computer, those skilled in the art will recognize that the invention also may be implemented in combination with other program modules. Generally, program modules include routines, programs, components, data structures, etc., that perform particular tasks and/or implement particular abstract data types. Moreover, those skilled in the art will appreciate that the inventive methods may be practiced with other computer system configurations, including single-processor or multi-processor computer systems, minicomputers, mainframe computers, as well as personal computers, hand-held computing devices, microprocessor-based and/or programmable consumer electronics, and the like, each of which may operatively communicate with one or more associated devices. The illustrated aspects of the invention may also be practiced in distributed computing environments where certain tasks are performed by remote processing devices that are linked through a communications network. However, some, if not all, aspects of the invention may be practiced on stand-alone computers. In a distributed computing environment, program modules may be located in local and/or remote memory storage devices.

As used in this application, the term “component” is intended to refer to a computer-related entity, either hardware, a combination of hardware and software, software, or software in execution. For example, a component may be, but is not limited to, a process running on a processor, a processor, an object, an executable, a thread of execution, a program, and a computer. By way of illustration, an application running on a server and/or the server can be a component. In addition, a component may include one or more subcomponents.

With reference to FIG. 10, an exemplary system environment 1000 for implementing the various aspects of the invention includes a conventional computer 1002, including a processing unit 1004, a system memory 1006, and a system bus 1008 that couples various system components, including the system memory, to the processing unit 1004. The processing unit 1004 may be any commercially available or proprietary processor. In addition, the processing unit may be implemented as multi-processor formed of more than one processor, such as may be connected in parallel.

The system bus 1008 may be any of several types of bus structure including a memory bus or memory controller, a peripheral bus, and a local bus using any of a variety of conventional bus architectures such as PCI, VESA, Microchannel, ISA, and EISA, to name a few. The system memory 1006 includes read only memory (ROM) 1010 and random access memory (RAM) 1012. A basic input/output system (BIOS) 1014, containing the basic routines that help to transfer information between elements within the computer 1002, such as during start-up, is stored in ROM 1010.

The computer 1002 also may include, for example, a hard disk drive 1016, a magnetic disk drive 1018, e.g., to read from or write to a removable disk 1020, and an optical disk drive 1022, e.g., for reading from or writing to a CD-ROM disk 1024 or other optical media. The hard disk drive 1016, magnetic disk drive 1018, and optical disk drive 1022 are connected to the system bus 1008 by a hard disk drive interface 1026, a magnetic disk drive interface 1028, and an optical drive interface 1030, respectively. The drives 1016-1022 and their associated computer-readable media provide nonvolatile storage of data, data structures, computer-executable instructions, etc. for the computer 1002. Although the description of computer-readable media above refers to a hard disk, a removable magnetic disk and a CD, it should be appreciated by those skilled in the art that other types of media which are readable by a computer, such as magnetic cassettes, flash memory cards, digital video disks, Bernoulli cartridges, and the like, can also be used in the exemplary operating environment 1000, and further that any such media may contain computer-executable instructions for performing the methods of the present invention.

A number of program modules may be stored in the drives 1016-1022 and RAM 1012, including an operating system 1032, one or more application programs 1034, other program modules 1036, and program data 1038. The operating system 1032 may be any suitable operating system or combination of operating systems. By way of example, the application programs 1034 and program modules 1036 can include an optimization scheme for dissemination of data from a source node to network nodes in accordance with an aspect of the present invention.

A user can enter commands and information into the computer 1002 through one or more user input devices, such as a keyboard 1040 and a pointing device (e.g., a mouse 1042). Other input devices (not shown) may include a microphone, a joystick, a game pad, a satellite dish, wireless remote, a scanner, or the like. These and other input devices are often connected to the processing unit 1004 through a serial port interface 1044 that is coupled to the system bus 1008, but may be connected by other interfaces, such as a parallel port, a game port or a universal serial bus (USB). A monitor 1046 or other type of display device is also connected to the system bus 1008 via an interface, such as a video adapter 1048. In addition to the monitor 1046, the computer 1002 may include other peripheral output devices (not shown), such as speakers, printers, etc.

It is to be appreciated that the computer 1002 can operate in a networked environment using logical connections to one or more remote computers 1060. The remote computer 1060 may be a workstation, a server computer, a router, a peer device or other common network node, and typically includes many or all of the elements described relative to the computer 1002, although, for purposes of brevity, only a memory storage device 1062 is illustrated in FIG. 10. The logical connections depicted in FIG. 10 can include a local area network (LAN) 1064 and a wide area network (WAN) 1066. Such networking environments are commonplace in offices, enterprise-wide computer networks, intranets and the Internet.

When used in a LAN networking environment, for example, the computer 1002 is connected to the local network 1064 through a network interface or adapter 1068. When used in a WAN networking environment, the computer 1002 typically includes a modem (e.g., telephone, DSL, cable, etc.) 1070, or is connected to a communications server on the LAN, or has other means for establishing communications over the WAN 1066, such as the Internet. The modem 1070, which can be internal or external relative to the computer 1002, is connected to the system bus 1008 via the serial port interface 1044. In a networked environment, program modules (including application programs 1034) and/or program data 1038 can be stored in the remote memory storage device 1062. It will be appreciated that the network connections shown are exemplary, and other means (e.g., wired or wireless) of establishing a communications link between the computers 1002 and 1060 can be used when carrying out an aspect of the present invention.

In accordance with the practices of persons skilled in the art of computer programming, the present invention has been described with reference to acts and symbolic representations of operations that are performed by a computer, such as the computer 1002 or remote computer 1060, unless otherwise indicated. Such acts and operations are sometimes referred to as being computer-executed. It will be appreciated that the acts and symbolically represented operations include the manipulation by the processing unit 1004 of electrical signals representing data bits which causes a resulting transformation or reduction of the electrical signal representation, and the maintenance of data bits at memory locations in the memory system (including the system memory 1006, hard drive 1016, floppy disks 1020, CD-ROM 1024, and remote memory 1062) to thereby reconfigure or otherwise alter the computer system's operation, as well as other processing of signals. The memory locations where such data bits are maintained are physical locations that have particular electrical, magnetic, or optical properties corresponding to the data bits.

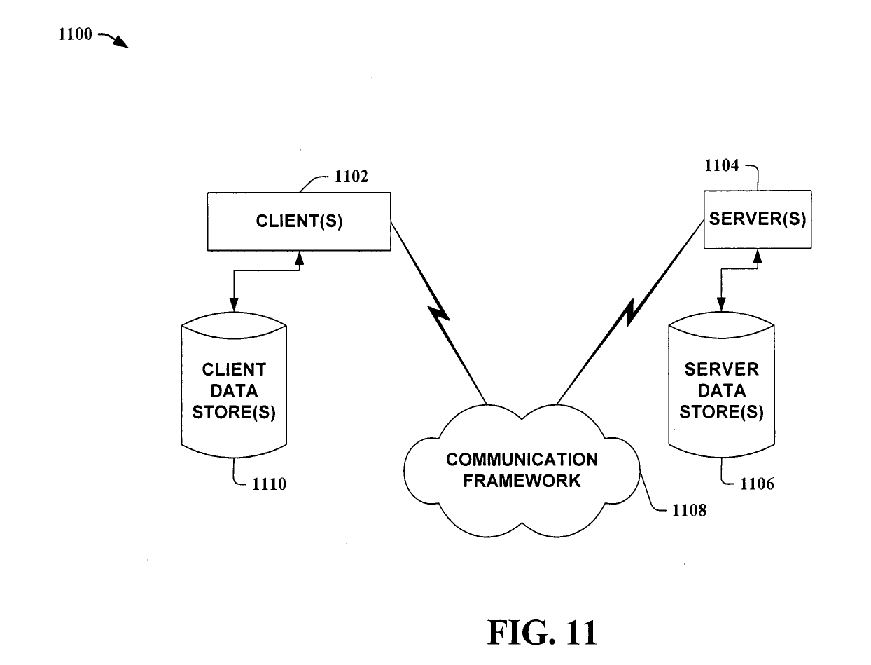

FIG. 11 is another block diagram of a sample computing environment 1100 with which the present invention can interact. The system 1100 further illustrates a system that includes one or more client(s) 1102. The client(s) 1102 can be hardware and/or software (e.g., threads, processes, computing devices). The system 1100 also includes one or more server(s) 1104. The server(s) 1104 can also be hardware and/or software (e.g., threads, processes, computing devices). The servers 1104 can house threads to perform transformations by employing the present invention, for example. One possible communication between a client 1102 and a server 1104 may be in the form of a data packet adapted to be transmitted between two or more computer processes. The system 1100 includes a communication framework 1108 that can be employed to facilitate communications between the client(s) 1102 and the server(s) 1104. The client(s) 1102 are operably connected to one or more client data store(s) 1110 that can be employed to store information local to the client(s) 1102. Similarly, the server(s) 1104 are operably connected to one or more server data store(s) 1106 that can be employed to store information local to the servers 1104.

In one instance of the present invention, a data packet transmitted between two or more computer components that facilitate distribution optimization, the data packet is comprised of, at least in part, information relating to optimizing distribution on at least one networked system, the optimized distribution based on an approximated optimization solution for a primal linear program resolved utilizing a same separation oracle employed to determine feasibility of a dual linear program representative of the primal linear program.

In another instance of the present invention, a computer readable medium storing computer executable components of a system for optimizing distributions of a network, the system comprised of, at least in part, an optimization system that determines an optimized distribution of a networked system based on an approximated optimization solution for a primal linear program resolved utilizing a same separation oracle employed to determine feasibility of a dual linear program representative of the primal linear program.

It is to be appreciated that the systems and/or methods of the present invention can be utilized in optimization systems facilitating computer components and non-computer related components alike. Further, those skilled in the art will recognize that the systems and/or methods of the present invention are employable in a vast array of electronic related technologies, including, but not limited to, computers, servers and/or handheld electronic devices, and the like.

What has been described above includes examples of the present invention. It is, of course, not possible to describe every conceivable combination of components or methodologies for purposes of describing the present invention, but one of ordinary skill in the art may recognize that many further combinations and permutations of the present invention are possible. Accordingly, the present invention is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A system that facilitates approximating a solution to a linear program, comprising:
a component that receives a subset of data corresponding to the linear program; and
an analysis component that adapts linear programming optimization algorithms, based on separation oracle(s), to work with an approximate separation oracle and the subset of data to solve a primal and dual linear program within a same approximation factor as the approximate separation oracle.

2. The system of claim 1, the analysis component resolving an optimization of the dual linear program to solve for an optimization of the primal linear program.

3. The system of claim 2, the optimization of the dual linear program comprising an approximate range between R* and αR*; where α is the approximation factor and R* is a minimum value produced by a binary search of an equality function produced via an ellipsoid algorithm utilizing the approximate separation oracle.

4. The system of claim 3, the optimization of the primal linear program comprising a value less than or equal to αR*.

5. The system of claim 1, the approximate separation oracle comprising an approximation algorithm for a minimum Steiner tree problem.

6. The system of claim 1, the approximate separation oracle utilized in conjunction with an ellipsoid method to obtain a resolution for the primal and dual linear programs.

7. The system of claim 6, the resolution producing an approximation algorithm for a fractional Steiner tree packing problem.

8. The system of claim 1, the analysis component utilizing primal and dual linear programs representative of a fractional Steiner tree packing problem.

9. The system of claim 1, the primal linear program comprising a representation of an aspect of at least one computer network system.

10. The system of claim 1, the subset of data comprising parametric data of a networked system.

11. The system of claim 10, the parametric data comprising capacity data relating to at least one link of the networked system.

12. The system of claim 10, the parametric data comprising length data relating to at least one link of the networked system.

13. The system of claim 10, the parametric data comprising cost data relating to at least one link of the networked system.

14. The system of claim 10, the parametric data comprising latency data relating to at least one link of the networked system.

15. The system of claim 1, the analysis component has an asymptotic approximation factor of about 1.59.

16. A method for approximating a distribution optimization, comprising:
obtaining desired parameter data from a networked system for utilization in determining an optimum distribution; and
determining the optimum distribution utilizing an approximate separation oracle in an ellipsoid method to solve primal and dual linear programs that represent a fractional Steiner tree packing problem.

17. The method of claim 16, further comprising:
obtaining the primal linear program for Steiner trees in the networked system;
determining the dual linear program based on the primal linear program; where a separation oracle of the dual linear program equates to a Steiner tree problem which is NP-hard to solve;
selecting a known approximation method for resolving a minimum weight Steiner tree problem;
utilizing the known approximation method as the approximate separation oracle in the ellipsoid method to provide a resolution to the dual linear program; and
employing the resolution of the dual linear program to provide a solution for the primal linear program to facilitate in finding an approximate maximum fractional packing of the Steiner trees in the networked system.

18. The method of claim 17, the known approximation method comprising a polynomial time α-approximation algorithm for finding the minimum weight Steiner tree.

19. The method of claim 18, further comprising:
employing a binary search to find a smallest value of R for which the dual linear program is feasible; where R represents a solution to the ellipsoid method utilizing the approximate separation oracle;
solving the dual linear program such that R* is a minimum feasible solution and αR* is a maximum feasible solution; where α is a performance factor of the approximate separation oracle;
setting the solution for the primal linear program equal to ≦αR*; and
providing an approximated optimization solution for the maximum fractional packing of the Steiner trees based on the solution for the primal linear program.

20. The method of claim 16, the approximate separation oracle having a performance ratio within approximately a 1.6 factor.

21. The method of claim 16, the networked system comprising a computer network.

22. The method of claim 21, the computer network comprising the Internet.

23. The method of claim 16, the desired network parameters including at least one from the group consisting of cost, length, capacity, and latency of links in the networked system.

24. The method of claim 16, further comprising:
utilizing the optimum distribution to efficiently transmit non-streaming data from a source node to a receiving node via the networked system.

25. The method of claim 16, the optimum distribution incorporating a broadcast transmission by the source node.

26. The method of claim 16, the optimum distribution incorporating a multicast transmission by the source node.

27. The method of claim 16, the optimum distribution incorporating a unicast transmission by the source node.

28. A system that facilitates approximating a solution to a linear program, comprising:
means for approximating an algorithmic solution to a minimum weight Steiner tree problem;
means for obtaining an approximate separation oracle for the algorithmic solution; and
means for utilizing the approximate separation oracle in an ellipsoid method to resolve primal and dual linear programs representative of a fractional Steiner packing tree problem to provide an optimal distribution for a networked system.

29. The system of claim 28, the networked system comprising at least one computer network.

30. A system that facilitates broadcast of non-streaming data, comprising:
a component that receives a subset of broadcast data; and
an approximation component that facilitates routing the subset of data, the approximation component employs a generalized ellipsoidal algorithm that works with an approximate separation oracle to solve a primal and dual linear program within a same approximation factor as the approximate separation oracle.

31. A data packet transmitted between two or more computer components that facilitate dissemination of data, the data packet comprising, at least in part, information relating to optimizing distribution on at least one networked system, the optimized distribution based on an approximated optimization solution for a primal linear program resolved utilizing a same separation oracle employed to determine feasibility of a dual linear program representative of the primal linear program.

32. A computer readable medium having stored thereon computer executable components of the system of claim 1.

33. A device employing the method of claim 16 comprising at least one selected from the group consisting of a computer, a server, and a handheld electronic device.

34. A device employing the system of claim 1 comprising at least one selected from the group consisting of a computer, a server, and a handheld electronic device.
